(19) United States
(12) Patent Application Publication
(10) Pub. No.: US 2026/0089463 A1
(43) Pub. Date: Mar. 26, 2026

(54) SYSTEM FOR PROXIMITY-BASED GEOFENCED CONTROL OF REMOTE TRANSCEIVER

(71) Applicant: Truist Bank, Charlotte, NC (US)

(72) Inventors: Jamie Nathaniel Franklin, Charlotte, NC (US); Hayden Rebecca Thomas, Charlotte, NC (US)

(73) Assignee: Truist Bank, Charlotte, NC (US)

(21) Appl. No.: 18/890,834

(22) Filed: Sep. 20, 2024

(51) Int. Cl. H04W 4/021; G06Q 30/0238; G06Q 30/0251; G08B 7/06; H04W 4/029

(52) U.S. Cl. CPC H04W 4/021; G06Q 30/0238; G06Q 30/0258; G06Q 30/0261; G06Q 30/0267; G08B 7/06; H04W 4/029

(57) ABSTRACT

A method of operating a mobile banking platform includes communicating to a user device a listing of deals with each of the deals relating to a reward given to a user when completing a qualifying transaction via use of a payment card associated with the mobile banking platform. Each of the participating organizations offering a deal is associated with at least one place of business where the qualifying transaction is capable of taking place via an in-person use of the payment card, and each of the places of business is associated with a corresponding geofence bounding a geographic area. The method further includes monitoring whether the user device has entered into one of the geofences, and, upon entry into one of the geofences, automatically enrolling the user in the corresponding deal or sending a communication to the user device of the user regarding enrollment in the deal.

### FIELD

This invention relates generally to a mobile banking platform, and more particularly, embodiments of the invention relate to a mobile banking platform utilizing a location detecting means to automatically enroll a user of the mobile banking platform in a deal or discount relating to a purchase or transaction carried out with a payment card associated with the mobile banking platform, or to automatically prompt the user regarding potential enrollment of the user in the deal or discount.

### BACKGROUND

It has become increasingly common for various forms of payment cards associated with a financial institution (bank), such as debit cards, credit cards, or the like, to offer deals, discounts, or other incentives to a card holder with respect to transactions occurring at or with participating organizations. For example, a card holder may be able to navigate a mobile banking application or website associated with the financial institution in order to select certain deals that the card holder would like to utilize, such as choosing the ability to receive a discount with respect to a purchase at a retail establishment and/or a specific product offered by the retail establishment. Typically, such deals or discounts are often paid to the card holder in the form of a “cash back” refund applied to the balance of the credit or debit card upon enrollment in and use of the corresponding deal or discount. This arrangement benefits the card holder via the savings associated with the discounted price, and further benefits the financial institution and the participating organization offering the deal or discount via the increased traffic associated with the use of the credit or debit card at the participating organization. In some circumstances, the financial institution may also receive a fee or similar incentive from the participating organization each time the card holder takes advantage of such a deal.

Unfortunately, many card holders having the opportunity to utilize such deals are frequently unaware of the existence of the deals when attempting to make a purchase at a participating organization. That is, if the card holder has not proactively reviewed and selected the relevant deal from a list of available deals during navigation of the mobile banking application or website, the card holder does not receive the benefit of the available deal, even when using the credit or debit card having direct access to the deal in question upon enrollment therein.

Additionally, circumstances may occur where the card holder is shopping for or otherwise in need of a specific product while unaware that a deal is available with respect to one or more applicable organizations. For example, when searching for a sporting goods related gift, the card holder may be unaware that one of a variety of possible sporting goods stores is currently offering a significant discount that would lead the card holder to seek out the participating sporting goods store over competing sporting goods stores. As another example, a card holder may be seeking a restaurant at which the card holder can purchase a meal in a cost effective manner, and may overlook the availability of a deal rendering a certain preferable restaurant as within the current budget of the card holder. The card holder is accordingly unable to utilize the existence of such deals as a means to determine when and/or where to shop when certain needs arise.

Although the card holder may have continuous access to such deals or discounts via the corresponding mobile banking application or website, it may be cumbersome for the card holder to search through a list of participating establishments each time the card holder would like to receive the benefit of such a deal or discount. Additionally, the use of such features may typically not be at the forefront of the mind of the card holder, leading to numerous missed opportunities that would otherwise be enjoyed if only the card holder were more actively aware of the deals or discounts instantaneously available thereto. Lastly, where the card holder may utilize multiple different payment cards from multiple independent financial institutions, it may be especially unlikely that the card holder will search through all available deals among all possible payment cards (such as browsing lists on multiple different software applications) to determine which, if any, of the available payment cards is offering a deal and/or which deal is best suited to the instantaneous needs of the card holder.

In view of the above concerns, it would accordingly be beneficial to provide a system and method of appropriately informing the card holder of available deals or discounts associated with a payment card, and especially when the card holder is actively shopping at or in close proximity thereto to a participating organization offering a deal or discount via the payment card.

### BRIEF SUMMARY

Embodiments of the present invention address the above needs and/or achieve other advantages by providing apparatuses and methods that facilitate the automatic alerting and/or auto-enrollment of a user in a deal when the user is geographically proximate to a place of business where a qualifying transaction is capable of being made according to the corresponding deal.

Embodiments of the invention include computing system comprising at least one processor, a communication interface communicatively coupled to the at least one processor, and a memory device storing executable code that, when executed, causes the processor to communicate, to a user device of a user, a listing of one or more deals accessible to the user during execution of a mobile banking platform, as managed by the computing system, on the user device. Each of the deals relates to a reward being given to the user, following enrollment of the user in the corresponding deal, when the user completes a qualifying transaction with a participating organization via use of a payment card associated with the mobile banking platform. The user is, by default, not enrolled within each of the respective deals upon each of the respective deals initially being listed for viewing and available for enrollment by the user via navigation of the mobile banking platform. Each of the participating organizations offering one of the deals is associated with at least one place of business where the user is capable of completing one of the qualifying transactions associated with a corresponding one of the deals via an in-person use of the payment card. Each of the places of business is associated with a corresponding geofence, and each of the geofences bounds a geographic area associated with the corresponding one of the places of business. The processor further monitors, via use of a positioning device of the user device, whether the user device has entered into one of the geofences associated with a corresponding one of the deals and automatically performs at least one of the following actions when the user device is determined to have entered within one of the geofences: enroll the user in the corresponding one of the deals associated with the entered one of the geofences or send a communication to the user device of the user regarding enrollment of the user in the corresponding one of the deals associated with the entered one of the geofences.

A method of operating a mobile banking platform is also disclosed and includes the steps of communicating, to a user device of a user, a listing of one or more deals accessible to the user during execution of the mobile banking platform on the user device, each of the deals relating to a reward being given to the user, following enrollment of the user in the corresponding deal, when the user completes a qualifying transaction with a participating organization via use of a payment card associated with the mobile banking platform, wherein the user is, by default, not enrolled within each of the respective deals upon each of the respective deals initially being listed for viewing and available for enrollment by the user via navigation of the mobile banking platform, wherein each of the participating organizations offering one of the deals is associated with at least one place of business where the user is capable of completing one of the qualifying transactions associated with a corresponding one of the deals via an in-person use of the payment card, wherein each of the places of business is associated with a corresponding geofence, wherein each of the geofences bounds a geographic area associated with the corresponding one of the places of business; monitoring, via use of a positioning device of the user device, whether the user device has entered into one of the geofences associated with a corresponding one of the deals; and automatically performing at least one of the following actions when the user device is determined to have entered within one of the geofences: enrolling the user in the corresponding one of the deals associated with the entered one of the geofences or sending a communication to the user device of the user regarding enrollment of the user in the corresponding one of the deals associated with the entered one of the geofences.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 illustrates an enterprise system and environment thereof for engaging with a user during navigation of a mobile banking platform, in accordance with one embodiment of the present invention.

FIG. 2 is an exemplary display of a user device showing a listing of deals.

FIG. 3 is a schematic representation of a shopping area having places of business associated with circular geofences centered on point positions; and

FIG. 4 is a schematic representation of a shopping area having places of business associated with polygonal-shaped geofences with a predefined shape.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

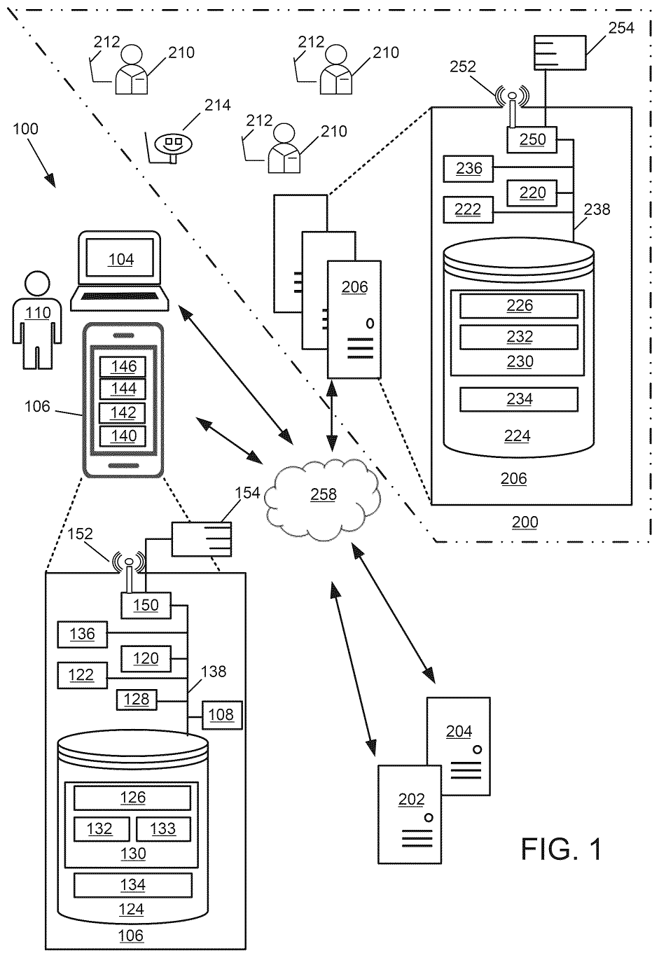

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. Each such user device 104, 106 includes appropriate components to act as a transceiver as utilized herein. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 106 and computing device 104, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the illustrated applications 132, 133 are represented as particular examples. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application. The mobile banking platform is associated with communications occurring via an appropriate transceiver (user device 104, 106), and may thus alternatively be referred to as a transceiver platform.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the mobile device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 106 and computing device 104, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the mobile device 106 during transactions and also configured to interact with the enterprise system 200 in back-end transactions clearing processes.

In certain embodiments, one or more of the systems such as the mobile device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared, as needed.

The present invention relates to interactions between the computing system 206 of the enterprise system 200 and a corresponding user 110 accessing a mobile banking platform associated with the enterprise system 200. As used herein, the mobile banking platform generally refers to a platform that is accessible to the user 110 via an appropriate network connection, such as a mobile banking website or a mobile banking software application. If the mobile banking platform refers to a mobile banking website, the user 110 may access the website via an appropriate browser software application operating on the corresponding user device 104, 106, wherein navigation of the mobile banking website provides the user 110 access to certain data regarding the user 110 as maintained by the enterprise system 200. If the mobile banking platform refers to a mobile banking software application, the user 110 may access the mobile banking software application via the corresponding user device 104, 106 for access to the data regarding the user 110 as maintained by the enterprise system 200 in the absence of the operation of the previously described browser application. The mobile banking software application may be representative of the previously described application 132 operable on the mobile device 106, as one non-limiting example. The invention is described hereinafter as utilizing the mobile banking application 132 operable on the mobile device 106 when referring to the mobile banking platform, wherein the mobile device 106 is in communication with any and all external systems, such as the computing system 206 of the enterprise system 200, via an appropriate wireless communication method such as the use of a cellular communication method.

It is generally assumed hereinafter that the same features of the mobile banking platform may be accessible via use of the mobile banking website accessible via the browser application or the direct use of the mobile banking software application, unless specified otherwise. It should also be generally understood that the website and the software application may generally include the display of the same data regarding the user 110, but may in some circumstances include a different arrangement of such data to best accommodate the configuration of the corresponding mobile device 106, such as accommodating a specific screen configuration or user input method. The mobile banking platform is described hereinafter as being “interacted with” by the user 110 during navigation thereof, wherein such interactions lead to selections of the user 110. It should be understood that such interactions may refer to any suitable interactions capable as acting as an input to the corresponding user mobile device 106, such as a corresponding touch screen interaction, mouse button click, keyboard stroke, voice activated command, or the like, as the circumstances may warrant. Such interactions are generally understood to correspond to a selection of an identifiable area of the display of the mobile banking platform, such as corresponding to a specific image, video display, text, or other representation of data, which in turn redirects the platform to change the data instantaneously displayed to the user 110.

The mobile banking platform is shown and described hereinafter with reference to the navigation of a dedicated mobile banking software application 132 as may be executed on the mobile device 106 having the touch screen display 140. However, as described above, it should be readily apparent that the same features may be applied to the corresponding software application or browser application during use of a corresponding computing device 104 while remaining within the scope of the present invention, so long as the same interactions occur between the mobile device 106, the user 110 thereof, and the associated enterprise system 200 managing the computing system 206.

As mentioned hereinabove, each of the users 110 described herein may be a person or entity acting as a customer or client of the enterprise system 200 that utilizes products and/or services from the enterprise system 200 as defined herein, or may otherwise be a person or entity having an established relationship with the enterprise system 200 such that the enterprise system 200 has access to the necessary personal data regarding each of the participating users 110 for making the determinations described hereinafter. The relationship present between the enterprise system 200 and a corresponding user 110 may include the user 110 having a user account with the enterprise system 200 wherein certain actions of the user 110, actions of the enterprise system 200, and/or interactions between the enterprise system 200 and the user 110 may be monitored and recorded by the computing system 206 of the enterprise system 200. Such data of each of the users 110 of the enterprise system 200 may be in the form of the data 234 stored to the memory device 222 and/or storage device 224 of the computing system 206 as utilized for carrying out the functions of the mobile banking platform as described herein. The data 234 may originate from various different sources including the recorded interactions of the user 110 with the enterprise system 200 and/or the recorded interactions of the user 110 with one or more third-party and external sources or systems, which may be representative of the previously disclosed external systems 202, 204.

The user account of each corresponding user 110 may refer to a primary or umbrella account of the user 110 from which data corresponding to various additional or subaccounts is accessible during navigation of the mobile banking platform. For example, upon providing the necessary login credentials to access the corresponding user account via the mobile banking platform, the logged-in user 110 may then be able to access each of a variety of different financial accounts maintained by the enterprise system 200 and associated with the user 110. As one non-limiting example, the user account of the user 110 may include access to each of a checking account, a savings account, and a credit card account, each of which is maintained or monitored in some form by the enterprise system 200 and associated with the user 110. However, the user account may include access to any form of financial account including a record of financial transactions associated with the financial account, such as debits, credits, or transfers between accounts, among other possible transactions. Each transaction of a corresponding financial account may be associated with certain data, such as a corresponding monetary amount and/or date of transaction, by which such transactions may be appropriately categorized or otherwise sorted.

The examples provided hereinafter generally correspond to the types of transactions that would be expected to occur when managing a user account associated with a corresponding payment card such as a debit card and/or a credit card associated with the user account, wherein various purchases, payments, and transfers of funds are typically monitored and recorded in managing such payment cards. However, it should be readily apparent that the same general concepts described herein may be applied to alternative financial accounts having the monitoring of similar data while remaining within the scope of the present invention. For example, the user account may further include the issuance of temporary gift cards or the like having a similar construction to a debit or credit card, as one additional non-limiting example.

The personal data accessible to the enterprise system 200 regarding the user 110 may include data regarding products and/or services offered to the user 110 by the enterprise system 200 relating to banking, checking, savings, investments, credit cards, automatic-teller machines, debit cards, loans, mortgages, personal accounts, business accounts, account management, credit reporting, credit requests, and credit scores, as non-limiting examples. The data may further include files such as those for user accounts, user profiles, user account balances, user transaction histories, user investment portfolios, past communications with the user, or files downloaded or received from other devices such as the user devices 104, 106 of the user 110.

The present invention is drawn towards a method of presenting deals, discounts, or other incentives to the user 110 when utilizing a payment card that is associated with the enterprise system 200, wherein such deals, discounts, or other incentives are referred to simply as “deals” hereinafter, for brevity. However, such offerings need not necessary refer to deals, and may thus be generally referred to as selections provided to the user 110. The payment card being associated with the enterprise system 200 indicates that certain data pertaining to the payment card, such as previous purchases, refunds, rewards, etc., are accessible when the user 110 has successfully logged into the mobile banking platform managed by the enterprise system 200, and more specifically the computing system 206 of the enterprise system 200. The user 110 having successfully logged into the corresponding mobile banking platform also indicates that the user 110 is able to navigate the mobile banking platform in a manner leading to the user 110 being able to review and/or enroll in certain deals that are indicated as being associated with the use of the payment card in making future transactions, such as making a purchase from a participating third-party organization, such as a retailer, restaurant, service provider, or the like. The participating organization may refer to any organization or group associated with such a deal. It is assumed herein that, by default, the user 110 is not automatically enrolled in such deals upon each of the respective deals initially being listed or otherwise provided to the user 110 for selection or association (enrollment) during navigation of the mobile banking platform, hence some action constituting a form of active enrollment must occur for the default status of non-enrollment with respect to each respective user 110 to change following the active listing of each associated deal.

The described deals are generally associated with the use of the payment card in completing a purchase with an expectation of a reward being assigned to the user 110, such as the user 110 having a percentage of the purchase price or a set monetary amount offered to the user 110 as a cash back reward, which can be redeemed by the user 110. The payment card may alternatively be referred to as the interactive device utilized in making such a transaction, wherein the interactive device may be provided in the form of a physical payment card or in the form of a digital wallet feature or the like as available via use of an appropriate user device 104, 106 having payment card information stored thereto and accessible for making such transactions. The redemption of such a reward may be facilitated during navigation of the corresponding mobile banking platform, such as the user 110 requesting that the cash back value be utilized in paying off a balance of the payment card, being added as a credit to the balance of a corresponding account such as a checking account, or being redeemed in another form, such as sending a payment to the user 110 or sending a gift item to the user of a corresponding value.

The present invention may be associated with any number of different relationships being present between the user 110, the enterprise system 200, the participating organization offering the deal during use of the payment card, and optionally another third-party organization associated with managing the deals that are accessible to the user 110 while remaining within the scope of the present invention, so long as the same processes are utilized in informing and/or enrolling the user 110 in the deals as explained hereinafter. In some embodiments, the enterprise system 200 may directly contract with one or more of the participating organizations in determining which deals are associated with the use of the payment card, what users 110 are able to access such deals, the terms and conditions of the use of the payment card when utilizing such deals, and/or the terms and conditions relating to any relationships present between the enterprise system 200 and the participating organizations when such deals are utilized. For example, the enterprise system 200 may directly contract with a participating organization regarding a cash back deal any time the user 110 completes a purchase at the participating organization via the payment card, which may include the participating organization transferring funds to the enterprise system 200 for covering the cash back amount, the enterprise system 200 itself covering some or all of the cash back amount, and/or any appropriate funds being transferred between the enterprise system 200 and the participating organization in accordance with the terms of the applicable contract, such as a fee not directly associated with the cash back amount being paid to the enterprise system 200 each time a purchase is made in accordance with an offered deal.

It should be understood that any such terms and conditions may be present with respect to the relationship present between the enterprise system 200 and the participating organization while remaining within the scope of the present invention, wherein it is assumed that any such agreement is intended to benefit all interested parties based on whatever factors are relevant to the enterprise system 200 and the participating organization. In such a circumstance, data regarding the deals that are associated with the participating organization may be communicated between the computing system 206 of the enterprise system 200, the mobile device 106 of the user 110, and the participating organization, which may be representative of one of the external system 202, 204 in signal communication with the user 110 and the enterprise system 200 via an appropriate network 258 in FIG. 1.

In other embodiments, one or more of the third party organizations may optionally be associated with the management of such deals, wherein such a third party organization may in some way be responsible for negotiating and/or managing the contractual relationships present between the enterprise system 200 and the participating organizations. For example, the optional third party organization may act as an intermediary that offers a service of negotiating the terms and conditions of such deals with the participating organizations and then presents these deals to the enterprise system 200 such that the deals in question are accessible to the account holders of the enterprise system 200, such as the users of a specific payment card. In other words, the enterprise system 200 may not be solely involved in acquiring such deals that are associated with a specific payment card, but may rely on the third party organization to discover such deals and arrange the terms and conditions by which these deals become accessible to the user 110 when navigating the mobile banking platform of the enterprise system 200. If such a third party organization is utilized, the third party organization may be representative of one of the external systems 202, 204 illustrated in FIG. 1, and may be responsible for transferring any necessary data to any one of the user 110, the enterprise system 200, and/or the participating organizations in ensuring that the deals as described herein are accessible to the user 110 when navigating the mobile banking platform of the enterprise system 200. The third party organization may have any contractual relationship with any of the described parties without departing from the scope of the present invention so long as the necessary data is accessible to the mobile device 106 of the user 110 in accordance with the present disclosure, as explained hereinafter, which may include any routing or storage of the necessary data to any one of the mobile device 106, the computing system 206, or any of the relevant external systems 202, 204.

The present invention includes the mobile device 106 proactively alerting the user 110 of the existence of a deal via an appropriate communication and/or actively enrolling the user 110 in such a deal when the user 110 is in proximity to a geographic location associated with the ability of the user 110 to utilize a qualifying payment card for conducting a qualifying transaction (purchase) with one of the participating organizations according to the terms of a corresponding one of the listed deals. The qualifying transaction may alternatively be referred to as a passing interaction as utilized herein. The geographic location generally refers to a physical structure at which the corresponding one of the participating organizations conducts business such that the use of the payment card may be expected to occur when the user 110 is visiting the physical structure and attempting to make a purchase. Such a physical structure may refer to any tangible structure or object having or forming a point-of-sale for completing a qualifying purchase via the payment card, such as a building, tent, kiosk, check-out counter, or the like, as non-limiting examples. Such physical structures may be referred to as places of business, and may refer to retail establishments, restaurants, service provider facilities, or the like, as non-limiting examples. As utilized herein, the terms geographic location, physical structure, and place of business may all be considered to be utilized interchangeably as each of the terms generally refer to the same concept regarding the ability to complete a qualifying purchase thereat.

For some participating organizations, a plurality of different and distinct geographic locations and corresponding physical structures may be associated with the ability to utilize one of the applicable deals, such as the ability to utilize the deal at each of the geographically distinct stores, restaurants, or facilities associated with one of the participating organizations offering a deal, such as different locations or franchises associated with a participating organization. Additionally, as explained hereinafter, the present invention may also include the alerting or enrollment of the user 110 when the user 110 is within a predefined distance or range of such a geographic location, depending on the circumstances and/or personal preferences of the user 110, which may generally be referred to as the user 110 being within a geofence associated with the geographic location, as explained hereinafter.

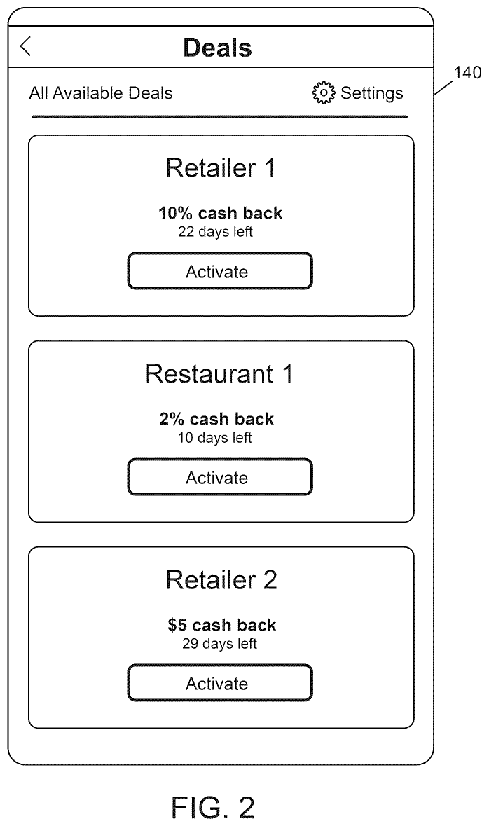

The automatic alerting and/or enrollment of the user 110 regarding a geographically proximate deal may be utilized in addition to the user 110 being able to enroll in such deals using a traditional enrollment procedure accessible by the user 110 during navigation of the corresponding mobile banking platform, as managed by the enterprise system 200. For example, FIG. 2 illustrates an exemplary depiction of the mobile banking platform as may be shown on the display 140 of the mobile device 106 of the user 110 after the user 110 has successfully logged into the account of the user 110, and after the user 110 has navigated the mobile banking platform to view a list of deals that are currently offered to the user 110 when utilizing a payment card associated with the mobile banking platform. For example, the illustrated deals may be applied whenever the user 110 utilizes any of a number of different payment cards, such as any associated debit cards or credit cards associated with the account of the user 110, as accessed during navigation of the mobile banking platform, in making a purchase with regards to a corresponding one of the participating organizations.

The present example of FIG. 2 includes the depiction of three different deals including a first deal of 10% cash back whenever a qualifying purchase is made at Retailer 1, a second deal of 2% cash back whenever a qualifying purchase is made at Restaurant 1, and a third deal of $5 cash back whenever a qualifying purchase is made at Retailer 2. As noted before, any types of participating organizations may be associated with the deals and any incentives may be associated with such deals in addition to the examples shown in FIG. 2. Each of the deals is also shown as having a period of time that the deal is to remain available, and each of the deals is further shown as being associated with the ability to activate the corresponding deal (enroll therein) via selection of an interactive area of the display 140 (an area of the screen that may be touched in the case of a touch screen display) labeled “Activate,” which results in the corresponding deal being applied to the account of the corresponding user 110 as a reward following use of one of the associated qualifying payment cards in making a qualifying transaction. It should be understood that alternative configurations of the display 140 and different methods of navigating the mobile banking platform may be utilized in activating such a deal and enrolling the user 110 in such a deal while remaining within the scope of the present invention.

The exemplary display 140 also indicates that the user 110 may interact with an area of the display 140 indicative of the ability to select settings associated with the deals offered by the enterprise system 200. However, it should once again be understood that any method of navigating the mobile banking platform may be utilized in selecting such settings, and hence the illustrated configuration including the settings selection being displayed adjacent the available and listed deals is non-limiting to the present invention. Such settings may include the ability of the user 110 to select whether or not to utilize the proximal alerting and/or enrollment of the user 110 with regards to such deals according to the present disclosure. The selection of the user 110 in utilizing the proximal alerting and/or enrollment may include the user 110 making multiple different determinations associated with the functionality of the described process, and may further request certain permissions from the user 110 associated with using certain features of the mobile device 106 in determining when the user 110 is in proximity to a geographical location that is associated with the ability to make a qualifying purchase in accordance with such a deal.

For example, the selection by the user 110 to utilize the proximal altering and/or enrollment may initially include the user 110 providing permission for the mobile banking platform to utilize the positioning device 108 of the mobile device 106 and/or the permission of the user 110 to share the current position of the mobile device 106 of the user 110 (as determined by the positioning device 108 thereof) with the computing system 206 of the enterprise system 200 for making determinations regarding the position of the user 110 relative to the geographic locations of any participating organizations. Generally, the positioning device 108 may refer to the GPS transceiver of the mobile device 106 for providing the most accurate determination of the geographic position of the mobile device 106 in terms of a set of corresponding GPS coordinates. However, the geographic position of the mobile device 106 may be determined by other means without departing from the scope of the present invention, including but not limited to triangulation of cellular signals to identify the approximate location of the mobile device 106, the use of a proximity sensor or transmitter, such as an RFID tag, that can sense or be sensed by devices known to be located proximate the geographic location to determine that the mobile device 106 is located proximate these known devices, or any other method of wirelessly identifying a position of the mobile device 106, as desired.

A method of monitoring the position of the user 110 may include the mobile banking application communicating with the computing system 206 of the enterprise system 200 continuously or periodically to determine whether the user 110 has come into proximity to a place of business of a participating organization during movement of the user 110 and the corresponding mobile device 106. That is, the computing system 206 may be responsible for maintaining storage of all relevant data regarding the range of coordinates corresponding to those areas considered to be proximal to one of the geographic locations of one of the participating organizations offering a deal such that the mobile device 106 does not need to retrieve and store such data itself, but instead need only communicate the current position of the mobile device 106 to the computing system 206 to allow the computing system 206 to then determine whether the mobile device 106 is in need of an alert and/or is automatically enrolled in a corresponding deal based on the reported geographic position thereof. The mobile device 106 accordingly sends data to the computing system 206 regarding the instantaneous position thereof before subsequently presenting the alert to the user 110 and/or automatically enrolling the user 110 upon receipt of data from the computing system 206 indicating that the mobile device 106 is proximate to one of the geographic locations. Under such circumstances, the user 110 must provide permission to utilize the positioning device 108 and must further provide permission for the computing system 206 to monitor the instantaneous position of the mobile device 106 before the present invention may be executed in the manner described herein.

In other embodiments, the computing system 206 may send data to the mobile device 106 regarding the position of each of the geographical locations associated with one of the participating organizations for storage on the mobile device 106, thereby removing the need for continuous communication between the mobile device 106 and the computing system 206 when attempting to determine whether the mobile device 106 has become proximate to a geographic location associated with one of the participating organizations for executing such a deal. Such a circumstance may in turn require only the permission of the user 110 to utilize the positioning device 108 during execution of the mobile banking platform with the mobile device 106 monitoring the current position thereof relative to the stored geographic locations of the participating organizations. The computing system 206 may be configured to only communicate the data regarding the geographic locations that are proximate to a specified position to avoid excessive data transfer, such as only communicating data regarding those geographic locations associated with participating organizations within a certain range of a zip code of the user 110 or a specific point position associated with the user 110 (such as an address thereof), as one non-limiting example.

With renewed reference to the settings available to the user 110, one possible selection of the user 110 may be related to whether the user 110 would like to receive an alert whenever it is determined that the user 110 is proximate to a geographical location associated with a deal (and not to automatically enroll) or whether the user 110 would like to automatically enroll in such a deal. If the selection of an alert is made in the absence of automatic enrollment, the manner in which the user 110 is alerted may also be provided as a possible sub-setting selection to be chosen by the user 110. For example, the user 110 may provide a selection regarding whether the mobile banking platform should send a push notification via the mobile banking platform and/or whether the user 110 should receive a traditional text message or email regarding the deal alert, among other possible alert methodologies associated with the mobile banking platform. The settings may also include a selection of the user 110 regarding what kind of information is provided via the alert and/or how the user 110 is to enroll in the deal following receipt of such an alert. For example, one selectable setting may correspond to the user 110 simply being informed that the user 110 is proximate to a geographic location of a participating organization offering an available deal (absent the ability to directly enroll in the deal via interaction with the associated communication) and/or such an alert may communicate specific details regarding the terms and conditions of the corresponding deal, among other information regarding such a deal. In contrast, an alternative form of selectable alert setting may indicate that the user 110 is to be prompted regarding the instant enrollment in the deal when the user 110 is viewing or otherwise accessing the alert, which may include the user 110 being led to an aspect of the mobile banking platform associated with enrolling in such a deal, such as automatically opening or otherwise accessing the mobile banking platform and directing the user 110 to a display similar to or the same as that proposed in FIG. 2. In other circumstances, the prompt may include the ability of the user 110 to make a selection when viewing the associated communication such that additional steps are not required on the part of the user 110 as the computing system 206 will actively take steps to enroll the user 110 absent the need of the user 110 to further navigate the mobile banking platform.

It should also be understood that the present invention may not include the user 110 having access to all such setting selections as described herein, wherein one or more of the described processes may be associated with the use of the proximal alerting of the user 110 to a deal absent the selection of the above features by the user 110. That is, any one or any combination of the described methods may be utilized in alerting the user 110 regardless of the user 110 being prompted to make such a selection, which may be based on the preferences of the enterprise system 200 regarding which options are available to the user 110 in carrying out the present invention.

When the automatic enrollment of the user 110 is selected as an active setting or is otherwise utilized, the automatic enrollment may occur in conjunction with an enrollment alert, which corresponds to a communication that indicates that the user 110 has just been automatically enrolled in the corresponding deal, being sent to the mobile device 106 upon the detection that the mobile device 106 is proximate to a corresponding geographic location. In other circumstances, the enrollment may occur absent the alerting of the user 110, and the updated status of the deal may only be viewed or evident when reviewing a listing of the activated deals of the user 110 during navigation of the mobile banking platform thereby. The decision regarding the sending of an alert upon the automatic enrollment in the deal may be provided as a further setting selection of the user 110, as desired. The automatic sending of an alert may once again occur via push notification (as facilitated by the mobile banking platform) or receipt of a text message/email, each of which provides the benefit of informing the user 110 of a potential deal in proximity to the user 110 while also skipping a step of requiring the user 110 to activate the deal or otherwise further interact with the mobile banking platform in confirming the desire to activate the deal.

The present invention may utilize any number of different methods in determining whether the mobile device 106 of the user 110 has become proximate to the geographic location (physical structure corresponding to a place of business) of a participating organization offering a deal, a variety of which are described in greater detail hereinafter. Assuming that the enterprise system 200 utilizes or offers the use of more than one of the following methods, the selection of the method preferred by the user 110 may be offered as one of the user selectable settings in the same manner as those settings described above.

One method that may be utilized in determining whether the mobile device 106 of the user 110 has become proximate to the geographic location of a participating organization offering a deal may be based on selecting one or more point positions associated with each geographic location that is associated with a participating organization, and then determining whether the mobile device 106 of the user 110 has come within a predetermined range or radius of each of the corresponding point positions, wherein each of the point positions may refer to a set of coordinates identifying a single position on the surface of the earth, such as the set of coordinates regarding the latitude and longitude of the point position. Each of the one or more point positions may be associated with a specific aspect of the building, structure, or other physical manifestation of the place of business of the participating organization corresponding to the geographic location. The method according to the present invention accordingly includes an alert being sent, or an auto-enrollment occurring, whenever the mobile device 106 of the user 110 is determined to have entered or otherwise be within a circular area centered on each specified point position as determined by a comparison of the reported GPS coordinates of the mobile device 106 to the known range of coordinates falling within such a circular area centered on the corresponding point position. Such a circular area may be referred to as a circular geofence in accordance with the present disclosure. Each circular geofence accordingly is associated with (covers) a geographic area on the surface of the Earth that is circular when viewed from above the geographic area, with the geofence extending vertically upwardly to bound a cylindrical shape extending from the circular perimeter shape.

For example, where only a single point position is utilized with respect to a geographic location, the single point position may be positioned such that the circular area within the range or radius thereof covers the entirety of the geographic area occupied by the corresponding physical structure at which a qualifying purchase may be made in accordance with the corresponding deal, such as positioning the single point position at or adjacent a center of the physical structure (as viewed from above). As another example, the single point position may be positioned at an entrance to the physical structure to ensure that all customers entering the physical structure are at some point within the range or radius of the single point position. In other circumstances, the single point position may be positioned within a parking lot or other such area associated with the physical structure where it is assumed that essentially all customers entering the physical structure will have first traveled there via a form of long-range transportation requiring access to such a parking area, or other such passenger unloading area in other circumstances. As yet another example, the single point position may be associated with the position of a point-of-sale within the physical structure, such as centering the circular area around a cash register associated with the participating organization and disposed within the physical structure, thereby ensuring that any user 110 making a purchase at the physical structure of the participating organization is within the corresponding circular area when attempting to make a qualifying purchase according to the deal.

Where more than one point position is utilized with respect to a geographic location corresponding to a participating organization, each of the different point positions about which one of the circular areas is centered may correspond to the configuration of the geofence disclosed with respect to any of the above circumstances, and may be provided in any combination thereof. For example, the point position of each entrance or exit from the physical structure may be associated with one of the circular areas such that all users 110 entering or exiting the physical structure are potentially alerted to or enrolled in the corresponding deal. Another possible scenario includes a circular area centered on each point position corresponding to each point-of-sale disposed at the physical structure such that multiple different point positions may be provided within physical structure at which the qualifying purchase can be made. Yet another example may include a circular area corresponding to the central region of the physical structure utilized in combination with a circular area associated with the primary parking lot, unloading area, or other tangible feature somehow associated with the physical structure. A final non-limiting example may include a combination of each entrance or exit being associated with a circular area and each point-of-sale being associated with a circular area, or only selected entrances/exits/points-of-sale among all such features.

The distance corresponding to the range or radius centered on each point position may be preselected by the enterprise system 200 as a default setting or may be provided as a selectable setting of the user 110. The selection of the range or radius may aid each user 110 in determining how frequent such alerts or auto-enrollments occur by limiting such events to only certain limited circumstances. For example, it may be cumbersome or overwhelming for the user 110 to receive a new alert each and every time the user 110 passes within a certain range of each physical structure associated with a participating organization, such as when the user 110 is driving on a roadway having multiple different physical structures associated with various participating organizations arranged thereon or thereby, or when the user 110 is within a mall or shopping center for which a plurality of different places of business associated with various participating organizations may be located. On the contrary, the user 110 may desire to be alerted when at a relatively great distance from one or more of the physical structures of the participating organizations such that the alerts or auto-enrollments are more likely to occur in a manner leading to an increased likelihood of the user 110 being aware of and/or eventually utilizing a corresponding deal, and especially in circumstances where the user 110 was not previously intending to make a purchase in accordance with such a deal. As non-limiting examples, the radius from the one or more point positions designated as corresponding to the geographic location/physical structure of a participating organization may be selected to be 25 ft, 50 ft, 100 ft, 150 ft, 200 ft, 500 ft, 1000 ft, a quarter of a mile, a half of a mile, or a mile. It is also conceivable that the user 110 may be provided with a setting selection wherein the user 110 specifies such a distance from each respective point position. It is also conceivable that the user 110 may select a setting corresponding to which type of point positions to utilize in determining the circular areas associated with the place of business, such as only those point positions corresponding to the central region of the physical structure, the parking area of the physical structure, the entrances/exits to the physical structure, the points of sale within the physical structure, or any combinations thereof.

A second method that may be utilized in determining whether the mobile device 106 of the user 110 has become proximate to the geographic location of a participating organization offering a deal may be for each of the geographic locations to be associated with a predefined geographic area having a preset virtual boundary or perimeter of any shape (other than merely a centered circular area), which may again be referred to as a geofence of the corresponding geographic location. The geofence may be configured to cover any shape that may be associated with the corresponding building or structure and/or any parking areas or transportation routes leading to the building or structure. The geofence may accordingly have an irregular shape with any series of straight or curved boundaries to fully cover the geographic areas considered to be associated with the geographic location of the participating organization. For example, the building or structure of the participating organization may include a polygonal shape with various extensions or the like extending from a central area, wherein it is desirable for the geofence to extend around all portions of the building or structure. The geofence may be provided to include a boundary shape corresponding to any buildings or structures associated with the geographic location, a boundary shape including or corresponding to any pathways, roadways, or parking areas associated with the geographic location, a boundary shape corresponding to a property boundary (property line) associated with the geographic location, or to combinations thereof, as desired. The geofence associated with such a boundary shape includes the vertical projection of the boundary shape away from the surface of the Earth to form a 3-dimensional shape within which the mobile device 106 may be deemed to have entered into the corresponding geofence.

In some circumstances, one of the participating organizations may be associated with two or more distinct geofenced areas to ensure that the user 110 is alerted or auto-enrolled in a variety of different circumstances with respect to a single place of business. For example, the parking lot of a shopping center or mall may include a first geofence covering the entirety of the parking lot that corresponds to any participating organizations found within the shopping center or mall, and each participating organization found within the shopping center or mall may be associated with a second geofence surrounding only the specific area of the shopping center or mall corresponding to the place of business of the participating organization, such as only those rooms of the shopping center or mall leased or owned by the participating organization. It is also conceivable that a single geofence may extend to cover a combination of different features of any given geographic location, such as bounding a combination of a parking area, a pathway or roadway leading to the building or structure or to the parking area, and the building or structure itself, as one non-limiting example of such a combination boundary shape.

In similar fashion to the above-described circular radial area, the user 110 may be prompted to select a size of the perimeter of the boundary corresponding to the geofenced area to satisfy the needs or desires of the user 110 in ensuring that too many or too few alerts or auto-enrollments do not occur with respect to the user 110 when near such a geofence area. For example, the user 110 may select to only utilize a geofence covering the perimeter shape of the building or structure or may select to utilize a geofence that extends 10 ft, 25 ft, 50 ft, etc. beyond the perimeter of the building or structure. Similarly, where the geofence includes multiple different aspects of the participating organization, the user 110 may select to only utilize the portions of the geofence corresponding to one or more of the different aspects. For example, the user 110 may select to only utilize those portions of the geofence corresponding to the perimeter of the building or structure to the exclusion of the parking area and any pathways/roadways leading to the building or structure, among any number of such combinations. That is, the user may be provided user selectable settings regarding whether certain forms or types of geofenced areas are utilized when monitoring for entry into such geofenced areas, such as choosing to utilize or to exclude those geofenced areas associated with buildings or structures, those geofenced areas associated with transportation routes, those geofenced areas associated with parking areas, those geofenced areas associated with points-of-sale, etc., so as to limit the circumstances under which an action occurs with respect to the user 110 upon entry into such geofenced areas.

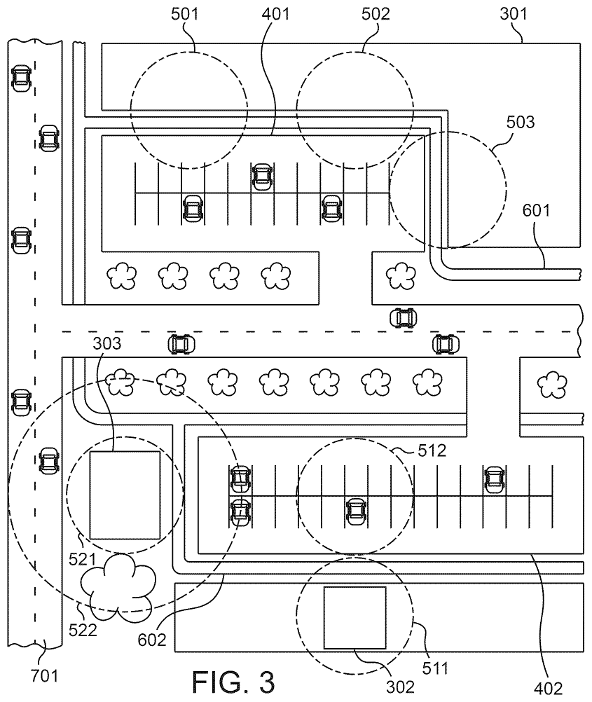

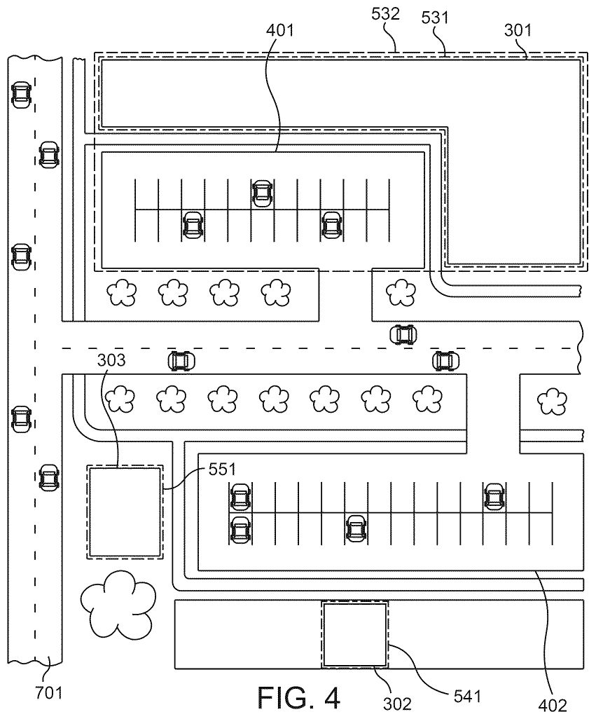

The above-described concepts regarding the use of a circular area centered on a point position for forming a circular geofence or the use of a virtual perimeter forming a geofence of any perimeter or boundary shape are illustrated in FIGS. 3 and 4. In FIG. 3, three different participating organizations having a deal associated with the enterprise system 200 are shown relative to various roadways, paths, and parking areas, wherein all geofences are associated with a circular area centered on a specific coordinate. A first retail establishment 301, which may be analogous to the Retailer 1 of the deal examples shown in FIG. 2, is shown as a substantially L-shaped building having a dedicated first parking lot 401. A second retail establishment 302, which may be analogous to the Retailer 2 of the deal examples shown in FIG. 2, is shown as a substantially square area of a shopping center or strip mall associated with a second parking lot 402. A first restaurant 303, which may be analogous to the Restaurant 1 of the deal examples shown in FIG. 2, is shown as a substantially rectangular building sharing the second parking lot 402 with the second retail establishment 302.

The first retail establishment 301 is shown as being associated with each of three different circular geofences 501, 502, 503 that cover only portions of the first retail establishment 301. In this example, each of the circular geofences 501, 502, 503 may be associated with a corresponding entrance/exit of the first retail establishment 301, or alternatively each of the circular geofences 501, 502, 503 may be associated with a corresponding point-of-sale where purchases can be made adjacent a perimeter of the first retail establishment 301. Each of the circular geofences 501, 502, 503 is further shown as extending across at least a portion of a first walkway 601 and the first parking lot 401 such that a user 110 may be alerted or auto-enrolled when passing by or approaching the first retail establishment 301. The circular geofences 501, 502, 503 are shown as having a relatively small radius that does not encroach on any adjacent roadways or the other described parking lot 402 to avoid the sending of alerts or the initiation of an auto-enrollment for those users 110 not attempting to approach and potentially shop at the first retail establishment 301.

The second retail establishment 302 is shown as being associated with each of two different circular geofences 511, 512, wherein the circular geofence 511 is centered on and covers the entirety of the portion of the shopping center housing the second retail establishment 302 while the circular geofence 512 is centered on a portion of the second parking lot 402 adjacent the second retail establishment 302. The two circular geofences 511, 512 accordingly correspond to alerting or auto-enrolling the user 110 when parking relative to the second retail establishment 302 or when within the second retail establishment 302, and additionally the circular geofence 511 also extends across a second walkway 602 that may be utilized in accessing the second retail establishment 302. The circular geofences 511, 512 are again shown as having relatively small radii to avoid circumstances where alerts or auto-enrollments occur with respect to users 110 that are not proximate the second retail establishment 302.

The first restaurant 303 is shown as being associated with two different circular geofences 521, 522 that may be associated with the user 110 having selected two alternative radius settings for customizing the reach of the circular geofences 521, 522. Specifically, the smaller radius circular geofence 521 is centered relative to the first restaurant 303 and does not extend over any roadways, but does extend over a portion of the second walkway 602, whereas the larger radius circular geofence 522 is also centered relative to the first restaurant 303 while extending across each of a portion of a first roadway 701, the second walkway 602, and the second parking lot 402. The larger radius circular geofence 522 may accordingly result in the sending of an alert or the initiation of an auto-enrollment with respect to the user 110 when passing by the first restaurant 303 despite the first user 110 not specifically intending to approach the first restaurant 303 to make a purchase.

Referring now to FIG. 4, the first retail establishment 301, the second retail establishment 302, and the first restaurant 303 are shown once again, but in this instance relative to non-circular geofences. Specifically, the first retail establishment 301 is shown relative to two different perimeter geofences 531, 532, wherein the geofence 531 includes an irregular L-shape to correspond to a perimeter shape of the building or structure forming the first retail establishment 301 such that the mobile device 106 will be determined to be within the geofence 531 any time the user 110 is within the perimeter of the building or structure, and wherein the geofence 532 includes a rectangular shape to encompass both the building or structure as well as the dedicated first parking lot 401 disposed adjacent thereto such that the mobile device 106 will be determined to be within the geofence 532 any time the user 110 is within the building or structure and any time the user 110 is parking in anticipation of entering the building or structure. The different geofences 531, 532 are shown as alternative examples that may be utilized in accordance with the above description of the geofencing process when applied to the first retail establishment 301. The second retail establishment 302 is shown as being associated with a substantially square geofence 541 that matches the substantially square perimeter shape of the second retail establishment 302 while the first restaurant 303 is shown as being associated with a substantially rectangular geofence 551 that matches the substantially rectangular perimeter shape of the first restaurant 303. Although not shown in FIG. 4, each of the geofences 531, 541, 551 matching the perimeter shape of each respective building or structure may also be provided to include an enlarged size relative to the corresponding perimeter shapes, such as being offset a set distance (10 ft, 25 ft, etc.) outside of the perimeter of each respective perimeter, as desired.

As can be seen with respect to FIGS. 3 and 4, there may exist circumstances wherein the user 110 having the mobile device 106 exits and then reenters one of the illustrated geofences once or more when moving relative to each of the participating organizations 301, 302, 303. Such a circumstance may lead to the undesirable outcome wherein the user 110 receives a plurality of different alerts corresponding to the same deal each time the user 110 reenters a corresponding geofence. In order to avoid such a circumstance, the method according to the present invention may include a limit to the number of such alerts that are sent with respect to any one geofence, and/or may include a set time period during which no new alerts are to be sent upon the sending of a prior alert. For example, upon the user 110 receiving a first alert regarding a deal at the first retail establishment 301 that the user 110 does not activate or enroll in following receipt of the first alert, the sending of a second alert regarding the same deal may not be sent until a set time period has elapsed, such as 1 hour, 6 hours, 1 day, or 1 week, as non-limiting examples. As another example, an alert may only be sent the first set number of times the mobile device 106 crosses a boundary for entering a geofence corresponding to the first retail establishment 301, and then no further alerts will be sent regarding this deal until the deal has elapsed. As yet another example, a set number of alerts may be sent within a specific time period, such as a limit of three per day, wherein the alerts are reset each subsequent day until the deal expires. According to alternative circumstances, the user 110 may be automatically enrolled in a deal or may otherwise be prompted and then select to utilize a deal upon entering a corresponding geofence, and may then leave and reenter the corresponding geofence. In similar fashion to the non-enrollment examples above, the method may include only sending further communications to the user 110 regarding the presence of the deal or the existing enrollment of the user 110 therein based on factors such as total number of communications already sent, the frequency of communications already sent, the time elapsing between successive communications, or combinations thereof, among other possible factors. The method may also include limiting the user 110 regarding receipt of additional communications when the user 110 is entering the geofence of a second place of business associated with the corresponding participating organization after having already been alerted/auto-enrolled with respect to the geofence associated with a first place of business of the participating organization having been previously entered by the user 110. Each of the described methods of limiting the alerts in quantity or within certain time periods may be provided as selectable settings in the same manner as described above with regards to previously described selectable settings, or may be established exclusively by the enterprise system 200.

The examples shown in FIGS. 3 and 4 also present multiple situations wherein it may be possible for alerts or auto-enrollments to undesirably occur when the user 110 having the mobile device 106 is not in any way attempting to make a purchase at a participating organization, such as when the user 110 is driving a vehicle along a roadway having a place of business of a participating organization disposed therealong with a geofence assigned to the place of business that extends into the roadway, such as shown with respect to the large radius circular geofence 522 in FIG. 3. The method according to the present invention may avoid such occurrences via a variety of different means. As one example, the use of the GPS transceiver of the mobile device 106 as the positioning device 108 allows for the calculation of the estimated instantaneous speed of mobile device 106 via a ratio of the distance traveled between two different instances and the time elapsed between the two different instances. Using this estimated speed, the process of sending alerts or auto-enrolling the user 110 in a deal can be prevented when the speed of the mobile device 106 is above a threshold value, such as whenever the mobile device 106 is traveling at a speed above 10 mph, 15 mph, 20 mph, 30 mph, etc., which would be considered indicative of situations where the user 110 is driving through the corresponding geofence. The method may also include the sending of alerts or auto-enrolling occurring only after the mobile device 106 has been below the specified speed for a set period of time, such as 10 sec, 20 sec, 30 sec, 1 min, 2 min, etc., thereby establishing that the driving process has ceased, as opposed to having been temporarily interrupted. In this way, the alerts and/or auto-enrollments can be avoided where the user 110 may drive by multiple such deals via the route taken by the user 110, or may slow down or stop briefly adjacent such establishments, such as a result of traffic conditions. The determination to utilize this feature and/or the chosen speed at which the alerts and/or auto-enrollments are disabled may also be provided as selectable settings that are selected by the user 110 in the same manner as described hereinabove with respect to previous described settings, or may not be offered.

Another method of disabling such alerts and/or auto-enrollments may include the mobile banking platform determining whether the mobile device 106 is currently in wireless communication with a vehicle of the user 110, such as determining whether a Bluetooth® connection has been established between the mobile device 106 and the vehicle of the user 110. This method may include the disabling of such alerts and/or auto-enrollments whenever such a connection is being made, which is indicative of the vehicle being operated and the mobile device 106 being in close proximity to the vehicle, which should in most instances correspond to the user 110 driving or riding within the vehicle in question. The use of this feature may once again be a selectable setting in similar fashion to those previously described, or may not be offered for selection.

The above-described settings relating to the mobile device 106 moving at a speed corresponding to the user 110 not utilizing high-speed transportation and/or relating to the mobile device 106 having a wireless connection with a corresponding vehicle may occur via the mobile device 106 only communicating the instantaneous position thereof to the computing system 206 when the mobile device 106 is not instantaneously moving too fast and/or connected to the corresponding vehicle as described above. As such, a signal indicating entry into a geofence is only sent by the mobile device 106 when all necessary conditions are met as monitored and determined by the mobile device 106, and the computing system 206 acts on the basis of the determinations made by the mobile device 106. As another example, the computing system 206 may receive all such signals originating from the mobile device 106 regardless of the condition (speed or connection status) thereof, and such signals may include information relating to the instantaneous condition of the mobile device 106 to allow the computing system 206 to then determine whether all conditions have been met for an action to be taken in accordance with the present invention.

Additional settings that may be selected by the user 110 may relate to which of the deals that have been provided to the user 110 for enrollment are to be associated with the alert/auto-enrollment process described herein to limit the circumstances in which such alerts are sent. For example, the user 110 may be given an option to select which among the available participating organizations the user 110 would like to be automatically enrolled in or alerted to deals with respect thereto, such as actively selecting to receive alerts/auto-enrollments from only certain selected organizations or choosing to receive all alerts/auto-enrollments except for those associated with certain selected organizations. Another example may be to allow the user 110 to generally select categories of participating organizations or the types of sales occurring thereat to limit the method to preferred circumstances. For example, a user 110 may select to only receive or omit alerts/auto-enrollments with respect to a broad category of organizations such as grocery stores, restaurants, retail stores, etc., thereby ensuring that excessive alerts/auto-enrollments do not occur with respect to categories that are not of interest of frequently shopped by the user 110. As yet another example, the user 110 may be able to specify to receive or omit certain selected deals for geofence monitoring on the basis of the type or amount of rewards offered by the deal, such as only requesting action be taken with respect to cash-back rewards, or only when a deal offers greater than a certain reward level, such as only deals of 2% cashback value or greater.

Each of the communications described as being sent from the computing system 206 to the mobile device 106 may be associated with setting off or otherwise initiating an alert feature of the corresponding mobile device 106 to ensure that the user 110 is made aware of receipt of the communication substantially contemporaneously with the detection of the mobile device 106 entering the corresponding geofence and the receipt of any resulting communication by the mobile device 106. Such an alert feature may refer to a graphic appearing on the display 140 upon receipt of the communication, a vibration of the mobile device 106 at the time of receipt of the communication, an audible alert sound in conjunction with receipt of the communication, an indicator (light or the like) disposed on an exterior of the mobile device 106 that discloses whether a new communication has been received, or the like, so long as the alert feature is intended to draw the attention of the user 110 to the mobile device 106 in a time sensitive manner such that the user 110 has an opportunity to remain within proximity to the corresponding geographic location when initially accessing and viewing the corresponding alert communication.

The mobile device 106 utilizing an alert feature thereof is thus highly relevant in those circumstances where a communication is the action deemed as most appropriate for the computing system 206 to take in reaction to entry into a geofence as the user 110 becoming aware of the communication while proximally located to the corresponding place of business greatly increases the likelihood that any deals associated with the place of business will actually be taken advantage of by the user 110 in accordance of the benefits of the present invention, whether the user 110 is previously enrolled, is contemporaneously being enrolled, or must still provide approval to be enrolled. Such an alert feature also benefits situations where the user 110 is automatically enrolled in a deal because any communication sent in conjunction with such an auto-enrollment will also alert the user 110 of the existence of the deal in a manner serving as an advertisement thereof due to the close proximity of the user 110 to a physical structure where a qualifying transaction may take place and also due to the recent awareness of the deal by the user 110.

As noted in the background of the present patent application, a typical concern associated with the offering of deals that are associated with the use of a payment card to make certain qualifying transactions relates to the general lack of awareness of many users 110 regarding the availability of such deals, whether referring to specific deals offered by specific participating organizations or the general existence of such a reward system for making such qualifying purchases. This tends to occur because the user 110 must typically seek out such deals actively during navigation of the corresponding mobile banking platform such that awareness of new or relevant deals is minimized or non-existent. Such a feature is accordingly underutilized by many users 110 to the detriment to all relevant parties seeking a benefit from the use of such deals, which may refer to the reward sought by each respective user 110, to any monetary incentives for the enterprise system 200 or a third party organization responsible for such deals when such deals are utilized, or to any benefits provided to the participating organizations for improving traffic and sales upon utilization of such deals at the places of business thereof. The mobile banking platforms and associated systems of the prior art accordingly fail to address this concern such that there is no mechanism to aid the user 110 in taking advantage of such deals, and especially not when in close proximity to a circumstance where such a deal may be rewarded via a qualifying purchase occurring within a relative short time frame.

The present invention accordingly presents a significant advancement in the technical field of mobile banking via the automatic facilitation of computer-implemented actions leading towards the eventual enrollment of the user 110 in a deal that, when utilized and redeemed, may present a potential (financial) benefit to any of the user 110, the enterprise system 200, the participating organization offering the deal, and in some circumstances the third party organization responsible for managing such relationships and coordinating such deals. The manner in which the computing system 206 automatically enrolls the user 110 in a deal or automatically sends a message regarding awareness of or approval regarding enrollment of the user 110 in a deal accordingly results in the computing system 206 providing an automatic and computer-implemented remedy to the stated problem of lack of awareness regarding such deals by ensuring that the user 110 is both made aware of and then able to instantly benefit from (via instantaneous enrollment) any deals that are immediately available to the user 110 as a result of being physically located near a point-of-sale where a qualifying transaction may take place. This essentially instantaneous process of determining that the user 110 has entered a geofence followed by the auto-enrolling of the user 110 or the sending of a communication to the user 110 otherwise relating to the deal or enrollment therein accordingly provides real-time intervention by the computing system 206 to ensure that the user 110 does not miss out on a potentially advantageous transaction for the user 110. Additionally, the present invention also aids each user 110 with respect to time management because the user 110 is able to take advantage of physical proximity to each position at which a qualifying transaction may take place upon receiving a communication such that the user 110 is more likely to accomplish multiple goals.

The disclosed system and method includes the computing system 206 automatically reconfiguring itself in reaction to the determination that the mobile device 106 of the user 110 has entered one of the geofences such that future actions and behaviors of the computing system 206 are altered in accordance with the objectives of the present invention and the described advancements of the present system and method over mobile banking systems and methods of the prior art. Specifically, the status of each deal with respect to each user 110, such as the enrollment status of the user 110 with respect to each deal or the historical data regarding prior communications or alerts sent to the user 110 with respect to the corresponding deal (for limiting communications under prescribed circumstances as discussed herein), may be based on the storage of corresponding data to the storage device 224 of the computing system 206. That is, the computing system 206 may reference stored settings, as reflected by corresponding data entries associated with the storage device 224, to determine whether the user 110 is enrolled in a deal, or whether the user 110 has already received a corresponding communication (or the like) where time/geographic limits are prescribed thereon, in determining which actions are to be taken by the computing system 206 when the computing system 206 makes a determination regarding the user 110 and mobile device 106 thereof entering a corresponding geofence.

The present system and method thereby results in the computing system 206 automatically reconfiguring such settings and/or storing new and/or different data, as stored to the storage device 224, in reaction to each detected entry into a geofence. The updating of all such data and/or settings results in the computing system 206 subsequently taking actions that reflect historical data regarding past occurrences with respect to the corresponding deal, geofence, and user 110, such as taking actions that align with data regarding prior or current enrollments, rejections of enrollment, communications sent regarding a deal, or the like that have previously taken place with respect to the corresponding user 110. The corresponding system and method thereby automatically readjusts the actions thereof to avoid circumstances wherein redundant or undesired communications are sent or undesired actions are taken.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A system for proximity-based geofenced control of remote transceiver, comprising:
at least one processor;
a communication interface communicatively coupled to the at least one processor; and
a memory device storing executable code that, when executed, causes the processor to:
communicate, to a transceiver of a user, a listing of one or more selections accessible to the user during execution of a transceiver platform, as managed by the computing system, on the transceiver, following association of the user in the corresponding selection, when the user completes a passing interaction with a group via use of an interaction device associated with the transceiver platform, wherein the user is, by default, not associated within each of the respective selections upon each of the respective selections initially being listed for display and available for association by the user via navigation of the transceiver platform, wherein each of the groups displaying one of the selections is associated with at least one physical location where the user is capable of completing one of the passing interaction associated with a corresponding one of the selections via an in-person use of the interaction device, wherein each of the physical locations is associated with a corresponding geofence, wherein each of the geofences bounds a geographic area associated with the corresponding one of the physical locations;
monitor, via use of a positioning device of the transceiver, whether the transceiver has entered into one of the geofences associated with a corresponding one of the selections; and
automatically perform at least one of the following actions when the transceiver is determined to have entered within one of the geofences:
associate the user in the corresponding one of the selections associated with the entered one of the geofences; or
send a communication to the transceiver of the user regarding association of the user in the corresponding one of the selections associated with the entered one of the geofences.

2. The system of claim 1, wherein, prior to monitoring whether the transceiver has entered into one of the geofences associated with a corresponding one of the selections, the executable code further causes the processor to provide a selection to the user, via navigation of the transceiver platform by the user, regarding permission for the computing system to receive data regarding a geographic position of the transceiver as determined by the positioning device thereof.

3. The system of claim 1, wherein the positioning device of the transceiver is a GPS transceiver.

4. The system of claim 3, wherein the computing system determines that the transceiver has entered into one of the geofences when the coordinates of the transceiver, as determined by the GPS transceiver thereof, fall within the range of coordinates corresponding to each of the respective geofences.

5. The system of claim 1, wherein one of the geofences is centered relative to a point position associated with the corresponding physical location.

6. The system of claim 5, wherein the point position is disposed within a physical structure comprising the physical location associated with the one of the geofences.

7. The system of claim 5, wherein the point position corresponds to a position of one of an entrance into or a point-of-sale within the physical location associated with the one of the geofences.

8. The system of claim 5, wherein the one of the geofences is circular in shape and is centered about the point position.

9. The system of claim 1, wherein one of the geofences includes a boundary shape corresponding to a boundary shape of the physical location associated with the one of the geofences.

10. The system of claim 8, wherein the boundary shape of the one of the geofences is irregular.

11. The system of claim 1, wherein one of the geofences includes a boundary shape that encompasses each of a physical structure of the associated physical location and a parking area of the physical location distinct from the physical structure thereof.

12. The system of claim 1, wherein the computing system determines whether to automatically associate the user with the corresponding one of the selections associated with the entered one of the geofences or automatically send the communication to the transceiver of the user regarding association of the user in the corresponding one of the selections associated with the entered one of the geofences according to a setting of the transceiver platform selectable by the user during navigation of the transceiver platform.

13. The system of claim 1, wherein the communication to the transceiver of the user regarding association of the user in the corresponding one of the selections associated with the entered one of the geofences includes a prompt to associate the user in the selection corresponding to the entered one of the geofences.

14. The system of claim 1, wherein, upon exiting and reentering one of the geofences corresponding to one of the selections in which the user has already been associated, the computing system sends a communication providing information regarding the corresponding one of the selections and the status of the user as associated therewith.

15. The system of claim 1, wherein receipt of the communication, by the transceiver of the user, regarding association of the user in the corresponding one of the selections associated with the entered one of the geofences is associated with activation of an alert feature of the transceiver.

16. The system of claim 15, wherein the alert feature relates to one or more of an audible sound, a displayed graphic, or a flashing light generated by the transceiver.

17. The system of claim 1, wherein the computing system is configured to automatically perform the at least one of the actions only when the transceiver is determined to be traveling at a speed below a predefined threshold.

18. The system of claim 1, wherein the computing system is configured to automatically perform the at least one of the actions only when the transceiver is determined to not be in active signal communication with a vehicle associated with the user.

19. The system of claim 1, wherein the interactive device is one of a credit card, a debit card, or a gift card.

20. A method of operating a transceiver platform comprising the steps of:
communicating, to a transceiver of a user, a listing of one or more selections accessible to the user during execution of the transceiver platform on the transceiver, each of the selections relating to a reward being given to the user, following association of the user in the corresponding selection, when the user completes a passing interaction with a group via use of a interactive device associated with the transceiver platform, wherein the user is, by default, not enrolled within each of the respective selections upon each of the respective selections initially being listed for viewing and available for association by the user via navigation of the transceiver platform, wherein each of the groups displaying one of the selections is associated with at least one physical location where the user is capable of completing one of the passing interactions associated with a corresponding one of the selections via an in-person use of the interactive device, wherein each of the physical locations is associated with a corresponding geofence, wherein each of the geofences bounds a geographic area associated with the corresponding one of the physical locations;
monitoring, via use of a positioning device of the transceiver, whether the transceiver has entered into one of the geofences associated with a corresponding one of the selections; and
automatically performing at least one of the following actions when the transceiver is determined to have entered within one of the geofences:
enrolling the user in the corresponding one of the selections associated with the entered one of the geofences; or
sending a communication to the transceiver of the user regarding association of the user in the corresponding one of the selections associated with the entered one of the geofences.
